(19) United States
(12) Patent Application Publication
(10) Pub. No.: US 2017/0099852 A1
(43) Pub. Date: Apr. 13, 2017

(54) ASSEMBLY OF AT LEAST ONE PLANT PROTEIN AND AT LEAST ONE MILK PROTEIN, PRODUCTION THEREOF AND USES OF SAME

(71) Applicants: ROQUETTE FRERES, Lestrem (FR); INGREDIA, Arras (FR)

(72) Inventors: Merveille NONO, Bethune (FR); Emmanuelle MORETTI, Lille (FR); Jean-Jacques SNAPPE, Festubert (FR); Isabelle COLIN, Anzin Saint Aubin (FR)

(21) Appl. No.: 15/127,124

(22) PCT Filed: Mar. 26, 2015
(86) PCT No.: PCT/FR2015/050780

§ 371 Date: Sep. 19, 2016

(30) Foreign Application Priority Data
Mar. 26, 2014 (FR) 14 52608

(51) Int. Cl. A23G 1/44; A23C 9/154; A23C 19/076; A23C 19/08; A23C 19/093; A23L 33/19; A23J 3/10; A23J 3/14; A23L 9/10; A23L 23/10; A23L 33/185; A23C 9/13; A23J 3/08

(52) U.S. Cl. CPC A23G 1/44; A23C 9/1315; A23C 9/1544; A23C 19/076; A23C 19/08; A23C 19/093; A23J 3/08; A23J 3/10; A23J 3/14; A23L 9/12; A23L 23/10; A23L 33/185; A23L 33/19; A23V 2002/00

(57) ABSTRACT

A novel method for producing an assembly of at least one milk protein and at least one plant protein in different food matrices or compositions. The assembly of at least one milk protein and at least one plant protein produced in this way, and the use of the assembly are also described.

### FIELD OF THE INVENTION

The subject of the present invention is a novel process for producing an assembly of at least one milk protein and at least one plant protein in various food compositions or matrices. The subject of the present invention is also the assembly of at least one milk protein and at least one plant protein thus obtained and also the use of this assembly.

### TECHNOLOGICAL BACKGROUND

Along with carbohydrates and lipids, proteins constitute a significant part of our diet. The proteins consumed are generally either of animal origin (meats, fish, eggs, dairy products, etc.) or of plant origin (cereals, leguminous plants, etc.).

Their nutritional role is to provide amino acids and energy, which are substrates required for the synthesis of the body's proteins.

Proteins are made up of a sequence of amino acids. There are 20 amino acids, including 9 which are essential to human beings, since the body does not know how to synthesize them and they must therefore be provided by the diet.

In the conventional approach, the quality of proteins is evaluated on the basis of their content of essential amino acids. It is in particular known that, as a general rule, proteins of animal origin are richer in certain essential amino acids than plant proteins.

Milk proteins are of advantageous nutritional value; on the other hand, they are expensive and this may curb their use. Manufacturers are therefore looking for substitute proteins, and plant proteins are attractive substitute proteins.

Many patent applications already describe the use of plant proteins for replacing all or some of the proteins of animal origin in foods. However, the substitute proteins currently available on the market do not necessarily have functionally optimal and advantageous properties, equivalent to the functional properties of the functional protein ingredients of animal origin.

For example, document EP 0 522 800 describes a process for treating a plant protein concentrate which makes it possible to enhance its functionality for binding fat and water, and also its use as a replacement for animal proteins in the manufacture of sausages. Document EP 0 238 946 describes an improved protein isolate originating from seeds of a grain legume with a relatively low lipid content, the process for preparing same and also the use thereof as an additive in the manufacture of sausages and saveloys.

Proteins play an important role in the organoleptic quality of many fresh or manufactured foods, for instance the consistency and the texture of meat and meat-based products, of milk and derivatives, of pasta and of bread. These qualities of foods very commonly depend on the structure, the physicochemical properties and the functional properties of the protein components of foods.

In the present application, the term “functional properties” of the food ingredients means any non-nutritional property which influences the usefulness of an ingredient in food. These various properties contribute to obtaining the desired final characteristics of the food. Some of these functional properties are the solubility, the hydration, the viscosity, the coagulation, the stabilization, the texturing, the paste formation, the foaming properties and the emulsifying and gelling capacities. Proteins also play an important role in the sensory properties of the food matrices in which they are used, and there is a real synergy between the functional properties and the sensory properties.

The functional properties of proteins, or functionality, are therefore the physical or physicochemical properties which have an effect on the sensory qualities of the food systems generated during technological transformations, storage or domestic culinary preparations.

It is noted that, whatever the origin of the protein, said protein has an influence on the color, the flavor and/or the texture of a product. These organoleptic characteristics have a determining influence on the choice made by the consumer and they are, in this case, greatly taken into account by manufacturers.

The functionality of proteins is the result of molecular interactions of the latter with their environment (other molecules, pH, temperature, etc.). These properties are generally classified into 3 groups:
hydration properties which group together the interactions of the protein with water: this covers the absorption, retention, wettability, swelling, adhesion, dispersion, viscosity, etc., properties,
structuring properties which group together the properties of protein-protein interaction: this covers the precipitation, coagulation, gelling, etc., phenomena,
surface properties which group together the properties of interaction of the proteins with other polar or nonpolar structures in the liquid or gas phase: this covers the emulsifying, foaming, etc., properties.

These various properties are not independent of one another since a functional property can result from several types of interactions or from several functional properties.

The applicant companies have noted that there is a real, unsatisfied, need to have available a composition which has advantageous functional properties, and which can be used in food as an at least partial substitute for proteins of animal origin.

In addition to this aspect linked to the functionality of the protein composition, the applicant companies have also noted that there is a need to have available protein compositions for nutritional purposes which can be used in applications in which requirements in terms of nutritional profile are sought and desired. The present invention also makes it possible to meet these objectives. Thus, the applicant companies have also been working at this search in order to be able to meet the increasing demands of manufacturers and consumers for compositions which have advantageous nutritional properties, without however having the drawbacks of certain already existing compositions.

In this context, the applicant companies have carried out research work relating to the production of novel assemblies of at least one milk protein and at least one plant protein and uses thereof in various food compositions.

### DESCRIPTION OF THE INVENTION

A subject of the present invention is a process for producing an assembly of at least one milk protein and at least one plant protein, said process comprising the steps consisting in:
preparing an aqueous composition comprising at least one plant protein by incorporating said at least one plant protein into water;
reducing the pH of said aqueous composition to a value of less than 5, and preferably less than or equal to 4.5, in order to obtain an acidified aqueous;
raising the pH of said acidified aqueous composition to a value of between 5 and 8, preferably between 5.5 and 7.5, even more preferentially to a value of between 6 and 7, and ideally to a value of 7;
introducing at least one milk protein into said aqueous composition obtained after the pH has been raised, in order to obtain a mixture;
homogenizing the mixture obtained.

Commonly, the term “assembly of proteins” is used to describe the bringing together of several proteins which together form a particular three-dimensional structure.

Indeed, proteins are made up of a succession of amino acids. The radical portion of amino acids bears different chemical functions. Thus, there may be interactions between the radicals of amino acids, typically hydrophobic interactions, hydrogen bonds, ionic bonds and disulfide bridges. The interactions between radicals have the effect of bringing about the folding of the proteins on themselves and between them so as to adopt a three-dimensional supramolecular structure. In that respect, the assembly of proteins differs from simple mixing: proteins are not simply physically mixed, but together form a new structure, having for example a particular size, morphology and composition.

In the present invention, the term “plant protein” denotes all the proteins derived from cereals, from oleaginous plants, from leguminous plants and from tubers, and also all the proteins derived from algae and from microalgae, used alone or as a mixture, chosen from the same family or from different families.

These plant proteins may be used alone or as mixtures with one another, chosen from the same family or from different families.

According to one preferential mode of the present invention, the plant protein is a leguminous-plant protein.

For the purposes of the present invention, the term “leguminous plants” is intended to mean any plants belonging to the families caesalpiniaceae, mimosaceae or papilionaceae and in particular any plants belonging to the family papilionaceae, for instance pea, bean, broad bean, horse bean, lentil, alfalfa, clover or lupin.

This definition includes in particular all the plants described in any one of the tables contained in the article by R. HOOVER et al., 1991 (HOOVER R. (1991) “Composition, structure, functionality and chemical modification of legume starches: a review” Can. J. Physiol. Pharmacol., 69 pp. 79-92).

In addition, according to one preferential mode, the leguminous-plant protein is chosen from the group consisting of alfalfa, clover, lupin, pea, bean, broad bean, horse bean and lentil, and mixtures thereof.

More preferably, said leguminous-plant protein is chosen from the group consisting of pea, bean, broad bean and horse bean, and mixtures thereof.

Even more preferably, said leguminous-plant protein is a pea protein.

The term “pea” is herein considered in its broadest accepted sense and includes in particular:
all varieties of “smooth pea” and of “wrinkled pea”, and
all mutant varieties of “smooth pea” and of “wrinkled pea”, this being whatever the uses for which said varieties are generally intended (food for human consumption, animal feed and/or other uses).

In the present application, the term “pea” includes the varieties of pea belonging to the Pisum genus and more particularly to the sativum and aestivum species.

Said mutant varieties are in particular those known as “r mutants”, “rb mutants”, “rug 3 mutants”, “rug 4 mutants”, “rug 5 mutants” and “lam mutants” as described in the article by C-L HEYDLEY et al. entitled “Developing novel pea starches”, Proceedings of the Symposium of the Industrial Biochemistry and Biotechnology Group of the Biochemical Society, 1996, pp. 77-87.

Even more preferentially, said leguminous-plant protein is derived from smooth pea. This is because the pea is the leguminous plant with protein-rich seeds which, since the 1970s, has been the most widely developed in Europe and mainly in France, not only as a protein source for animal feed, but also for food for human consumption.

Like all leguminous-plant proteins, pea proteins consist of three main classes of proteins: globulins, albumins and “insoluble” proteins.

The value of pea proteins lies in their good emulsifying capacities, their lack of allergenicity and their low cost, which makes them an economical functional ingredient. Furthermore, pea proteins contribute favorably to sustainable development and their carbon impact is very low. This is because pea cultivation is environmentally friendly and does not require nitrogenous fertilizers, since the pea fixes atmospheric nitrogen.

Pea proteins have a very particular amino acid profile, different than that of milk proteins or of other plant proteins. The amino acid profile of pea proteins is in particular rich:
in arginine, which plays an important role in physical exercise and in maintaining the immune system. Pea proteins contain more arginine than most of the other plant or animal proteins;
in lysine, which plays an important role in the growth of living beings, in particular in bone growth;
in amino acids which have a branched chain (isoleucine, leucine and valine) which help in maintaining and (re)constructing muscle tissues;
in glutamine and in glutamic acid, which are an energy source for muscles.

The aqueous composition comprising at least one plant protein may be in the form of an aqueous solution, dispersion or suspension of at least one plant protein. Preferably, it is a solution of at least one plant protein.

The composition comprising at least one plant protein, used in the process of the invention, advantageously has a total protein content (N×6.25) of at least 60% by weight of dry product. Preferably, in the context of the present invention, use is made of a composition having a high protein content, of between 70% and 97% by weight of dry product, preferably between 76% and 95%, even more preferentially of between 78% and 88%, and in particular of between 78% and 85%. The total protein content is measured by quantitatively determining the soluble nitrogenous fraction contained in the sample according to the Kjeldahl method. The total protein content is then obtained by multiplying the nitrogen content, expressed as percentage by weight of dry product, by the factor 6.25.

In addition, said composition comprising at least one plant protein, in particular one pea protein, can have a soluble protein content, expressed according to a test described hereinafter for measuring protein solubility in water, of between 20% and 99%. Preferably, in the context of the present invention, use is made of a composition having a high soluble protein content, of between 45% and 90%, even more preferentially between 50% and 80%, and in particular between 55% and 75%.

In order to determine the soluble protein content, the content of proteins soluble in water of which the pH is adjusted to 7.5+/−0.1 using a solution of HCl or NaOH is measured by means of a method of dispersion of a test specimen of the sample in distilled water, centrifugation and analysis of the supernatant. 200.0 g of distilled water at 20° C.+/−2° C. are placed in a 400 ml beaker and the whole is stirred magnetically (magnetic bar and rotation at 200 rpm). Exactly 5 g of the sample to be analyzed are added. The mixture is stirred for 30 min and centrifuged for 15 min at 4000 rpm. The method for determining nitrogen is carried out on the supernatant according to the method previously described.

The plant protein preferably contains more than 50%, more preferentially more than 60%, even more preferentially more than 70%, even more preferentially more than 80%, and in particular more than 90% of proteins of more than 1000 Da. The determination of the molecular weight of the protein can be carried out according to the method described hereinafter. In addition, these compositions comprising at least one plant protein, in particular one pea protein, preferably have a molecular weight distribution profile consisting of:
from 1% to 8%, preferably from 1.5% to 4% and even more preferentially from 1.5% to 3%, of proteins of more than 100 000 Da,
from 20% to 55%, preferably from 25% to 55%, of proteins of more than 15 000 Da and of at most 100 000 Da,
from 15% to 30% of proteins of more than 5000 Da and of at most 15 000 Da,
and from 25% to 55%, preferably from 25% to 50% and even more preferentially from 25% to 45%, of proteins of at most 5000 Da.

Examples of compositions comprising at least one plant protein, in particular one pea protein, according to the invention, and also the details of the method for determining the molecular weights, can be found in patent WO 2007/017572.

According to the present invention, the plant protein can for example be in the form of a plant protein concentrate, of a plant protein isolate or of a plant protein hydrolysate, preferably of a pea protein concentrate, of a pea protein isolate or of a pea protein hydrolysate.

The plant protein, and in particular pea protein, concentrates and isolates are defined from the viewpoint of their protein content (cf. review by J. GUEGUEN from 1983 in Proceedings of European Congress on plant proteins for human food (3-4) pp 267-304):
the plant protein, and in particular pea protein, concentrates are described as having a total protein content of from 60% to 75% on a dry basis, and
the plant protein, and in particular pea protein, isolates are described as having a total protein content of from 90% to 95% on a dry basis,
the protein contents being measured by the Kjeldhal method, the nitrogen content being multiplied by the factor 6.25.

The plant protein, and in particular pea protein, hydrolysates are defined as preparations obtained by enzymatic hydrolysis or chemical hydrolysis, or by both simultaneously or successively, of plant proteins, and in particular pea proteins. The protein hydrolysates comprise a higher proportion of peptides of various sizes and of free amino acids than the original composition. This hydrolysis can have an impact on the solubility of the proteins. The enzymatic and/or chemical hydrolysis is for example described in patent application WO 2008/001183. Preferably, the protein hydrolysis is not complete, i.e. does not result in a composition comprising only or essentially amino acids and small peptides (from 2 to 4 amino acids). The preferred hydrolysates comprise more than 50%, more preferentially more than 60%, even more preferentially more than 70%, even more preferentially more than 80%, and in particular more than 90%, of proteins and polypeptides of more than 500 Da.

The processes for preparing protein hydrolysates are well known to those skilled in the art and can, for example, comprise the following steps: dispersion of the proteins in water so as to obtain a suspension, and hydrolysis of this suspension by the chosen treatment. It will usually be an enzymatic treatment combining a mixture of various proteases, optionally followed by a heat treatment intended to inactivate the enzymes that are still active. The solution obtained can then be filtered through one or more membranes so as to separate the insoluble compounds, optionally the residual enzyme and the high-molecular-weight peptides (greater than 10 000 Daltons).

Thus, in one embodiment, the plant protein is in the form of a plant protein concentrate or of a plant protein isolate, preferably of a pea protein concentrate or of a pea protein isolate.

In another embodiment of the present invention, the composition comprising at least one plant protein, in particular one pea protein, is in the form of a plant protein hydrolysate, in particular pea protein hydrolysate.

According to one preferred embodiment of the invention, the compositions comprising at least one plant protein, in particular one pea protein, can undergo a preserving heat treatment at high temperature and for a short time before the pH-reducing step is carried out, it being possible for said treatment to be chosen from HTST (High Temperature Short Time) and UHT (Ultra High Temperature) treatments. This treatment advantageously makes it possible to reduce the bacteriological risks.

In the present invention, the term “milk protein” denotes all the proteins derived from milk and from milk-derived products. Generally, the milk proteins used in the process according to the invention can be in solid form, in particular in powder form, in pasty form or in liquid form, in particular in the form of a solution, dispersion or suspension, which are in particular aqueous, preferably in the form of a solution, more preferably in the form of an aqueous solution.

From a chemical point of view, milk proteins can be divided into two groups: caseins and serum proteins. The caseins represent 80% of the total proteins of milk. The serum proteins, which represent the remaining 20%, are soluble at pH 4.6. Among the serum proteins are principally β-lactoglobulin, α-lactalbumin, bovine serum albumin, immunoglobulins and lactoferrin.

The serum proteins are generally obtained by means of ultrafiltration, concentration and drying processes.

Caseins are obtained from skimmed milk and are precipitated either by acidification by means of acid or of harmless bacterial cultures suitable for human food (acid caseins), or by addition of rennet or other milk-coagulating enzymes (rennet caseins). Caseinates are the products obtained by drying acid caseins treated with neutralizing agents. According to the neutralizing agents used, sodium caseinates, potassium caseinates, calcium caseinates and mixed caseinates are obtained (=co-neutralization). Native caseins can be obtained from skimmed milk by tangential microfiltration and diafiltration with water. Generally, the milk protein can be chosen from caseins, caseinates, serum proteins and mixtures thereof.

According to one embodiment of the present invention, the at least one milk protein is a casein or a caseinate, or a mixture of the two. The milk protein is preferably a casein. The caseins can be chosen from the group consisting of native caseins, acid caseins, rennet caseins, and caseinates from the group consisting of sodium caseinates, potassium caseinates and calcium caseinates.

According to another embodiment of the present invention, the milk protein is a serum protein.

According to another embodiment of the present invention, the at least one milk protein is a mixture of casein and serum protein.

According to one embodiment of the present invention, the milk protein is in the form of a milk protein retentate, preferably of a casein retentate, more particularly of a micellar casein retentate.

According to one optional embodiment, the at least one milk protein may undergo a preserving heat treatment before introduction into the aqueous composition comprising at least one plant protein. Treatment of foods by heat (or heat treatment) is today the most important technique for long-term preservation. The objective thereof is to totally or partially destroy or inhibit the enzymes and microorganisms, the presence or proliferation of which could modify the food product under consideration or make it unfit for consumption.

The effect of a heat treatment is related to the time/temperature couple. Generally, the higher the temperature and the longer the duration, the greater the effect will be. Depending on the desired effect, several heat treatments are distinguished.

Heat sterilization consists in exposing the foods to a temperature, generally greater than 100° C., for a period of time sufficient to inhibit the enzymes and any form of microorganisms, even sporulating bacteria. When the sterilization is carried out at high temperature (135° C. to 150° C.) for a period not exceeding 15 seconds, the term UHT (Ultra High Temperature) sterilization is used. This technique has the advantage of preserving the nutritional and organoleptic quality of the product sterilized.

Pasteurization is a moderate and sufficient heat treatment which makes it possible to destroy pathogenic microorganisms and a large number of spoilage microorganisms. The treatment temperature is generally less than 100° C. and the time is a few seconds to a few minutes. When the pasteurization is carried out at a minimum of 72° C. for 15 seconds, the term HTST (High Temperature Short Time) pasteurization is used. Pasteurization destroys the pathogenic microorganisms and most of the saprophytic flora. However, since not all microorganisms are eliminated by pasteurization, this heat treatment must be followed by abrupt cooling. The pasteurized foods are then usually stored in the cold (+4° C.) in order to slow down the development of the microorganisms still present, and the shelf life is usually limited to one week.

Thermization is a heat treatment consisting in bringing the solution to a temperature greater than 40° C. and less than 72° C. It is a lesser form of pasteurization. Its main objective is to reduce the total flora of milk, without however modifying its technological characteristics.

According to the present invention, said heat treatment may be chosen from the treatments pre-listed above; preferably, pasteurization, in particular HTST pasteurization, will be chosen.

Preferably, the (weight of nitrogenous matter provided by the composition comprising at least one plant protein) to (weight of nitrogenous matter provided by the composition comprising at least one milk protein) ratio is between 99:1 and 1:99, more preferentially between 80:20 and 20:80, even more preferentially between 65:35 and 35:65.

In the above ratio, the respective weights of total proteins are measured by the method by assaying the soluble nitrogenous fraction contained in the sample according to the Kjeldahl method. The total protein content is then obtained by multiplying the nitrogen content, expressed as percentage by weight of dry product, by the factor 6.25. This method is well known to those skilled in the art.

The step of reducing the pH of the aqueous composition comprising at least one plant protein can be carried out by adding an acid to this aqueous composition, and preferably an acid of which the use is authorized in the food-processing field. The acid can, for example, be chosen from the group consisting of hydrochloric acid, acetic acid, phosphoric acid, citric acid, sorbic acid, benzoic acid, tartaric acid, lactic acid, propionic acid, boric acid, malic acid and fumaric acid. The addition of the acid may optionally be accompanied by stirring of the aqueous composition.

The acidified composition of plant proteins may optionally be stirred for a period of at least 15 minutes, more preferentially of at least 30 minutes, even more preferentially of at least 1 hour and in particular of at least 2 hours. This stirring advantageously promotes the dissociation or the dissolving of the plant proteins in the acidified composition. This stirring step can be carried out at a temperature which promotes dissociation or dissolving, preferably between 1° C. and 100° C., more preferentially between 2° C. and 40° C., and even more preferentially between 4° C. and 35° C.

The step of raising the pH of the acidified composition can be carried out by adding to the mixture an alkali, preferably an alkali of which the use is authorized in the food-processing field. The base may, for example, be chosen from the group consisting of sodium hydroxide, sodium sorbate, potassium sorbate, calcium sorbate, sodium benzoate, potassium benzoate, potassium benzoate, sodium formate, calcium formate, sodium nitrate, potassium nitrate, potassium acetate, potassium diacetate, calcium acetate, potassium diacetate, calcium acetate, ammonium acetate, sodium propionate, calcium propionate and potassium propionate. The addition of the base may optionally be accompanied by stirring of the mixture, for a period of at least 15 minutes, more preferentially of at least 30 minutes, even more preferentially of at least 1 hour and in particular of at least 2 hours.

This stirring step can be carried out at a temperature which promotes dissociation or dissolving, preferably between 1° C. and 100° C., more preferentially between 2° C. and 40° C., and even more preferentially between 4° C. and 35° C.

In one preferred embodiment, the pH is raised to a pH of 7. The term neutralization is then used.

The mixture obtained after introduction of the at least one milk protein into the aqueous composition comprising at least one plant protein, obtained at the end of the step of raising the pH, can also be subjected to a preserving heat treatment. Treatment of foods by heat (or heat treatment) is today the most important technique for long-term preservation. The objective thereof is to totally or partially destroy or inhibit the enzymes and microorganisms, the presence or proliferation of which could modify the food product under consideration or make it unfit for consumption.

The effect of a heat treatment is related to the time/temperature couple. Generally, the higher the temperature and the longer the duration, the greater the effect will be. Depending on the desired effect, several heat treatments are distinguished.

Heat sterilization consists in exposing the foods to a temperature, generally greater than 100° C., for a period of time sufficient to inhibit the enzymes and any form of microorganisms, even sporulating bacteria. When the sterilization is carried out at high temperature (135° C. to 150° C.) for a period not exceeding 15 seconds, the term UHT (Ultra High Temperature) sterilization is used. This technique has the advantage of preserving the nutritional and organoleptic quality of the product sterilized.

Pasteurization is a moderate and sufficient heat treatment which makes it possible to destroy pathogenic microorganisms and a large number of spoilage microorganisms. The treatment temperature is generally less than 100° C. and the time is a few seconds to a few minutes. When the pasteurization is carried out at a minimum of 72° C. for 15 seconds, the term HTST (High Temperature Short Time) pasteurization is used. Pasteurization destroys the pathogenic microorganisms and most of the saprophytic flora. However, since not all microorganisms are eliminated by pasteurization, this heat treatment must be followed by abrupt cooling. The pasteurized foods are then usually stored in the cold (+4° C.) in order to slow down the development of the microorganisms still present, and the shelf life is usually limited to one week.

Thermization is a heat treatment consisting in bringing the solution to a temperature greater than 40° C. and less than 72° C. It is a lesser form of pasteurization. Its main objective is to reduce the total flora of milk, without however modifying its technological characteristics.

According to the present invention, said heat treatment may be chosen from the treatments pre-listed above; preferably, pasteurization, in particular HTST pasteurization, will be chosen.

The step of homogenization of the mixture comprising the plant and milk proteins makes it possible to obtain better dissolution of the plant proteins and to promote interactions between the plant proteins and the milk proteins.

The homogenization can be carried out according to techniques known to those skilled in the art. A particularly preferred technique is high-pressure homogenization. It is a physical treatment during which a liquid or pasty product is sprayed under high pressure through a homogenization head of particular geometry. This treatment results in a reduction in the size of the solid or liquid particles which are in dispersed form in the product treated. The pressure of the high-pressure homogenization is typically between 30 bar and 1000 bar. In the process which is the subject of the present invention, this pressure is preferably between 150 bar and 500 bar, more preferentially between 200 bar and 400 bar, and even more preferentially between 250 bar and 350 bar. In addition, one or more homogenization cycles may be carried out. Preferably, the number of high-pressure homogenization cycles is between 1 and 4.

The homogenization may also be carried out using other known devices, for example chosen from mixers, colloidal mills, microbead mill homogenizers, ultrasonic homogenizers and valve homogenizers.

The homogenized mixture may optionally be concentrated. The process which is the subject of the invention can therefore also comprise a step of concentrating said composition. This concentrating step may optionally be carried out after a heat treatment step and/or a stabilizing step.

After concentration, the total content of proteins of the concentrated composition is preferably between 100 g/kg and 600 g/kg by weight of proteins relative to the total weight of the composition, more preferentially between 150 g/kg and 400 g/kg and in particular between 200 g/kg and 300 g/kg.

The process which is the subject of the invention can also comprise a step consisting in drying the homogenized, optionally concentrated, mixture. The drying mode may be chosen from techniques known to those skilled in the art, and in particular from the group consisting of spray-drying, extrusion and lyophilization, granulation, a fluidized bed, rolls under vacuum, and micronization.

The operating conditions of the drying step are suitable for the equipment chosen, so as to allow a powder to be obtained.

According to one preferential mode of the invention, the drying is carried out by spray-drying, according to the processes and parameters well known to those skilled in the art. The process which is the subject of the present invention makes it possible to obtain an assembly of at least one plant protein and of at least one milk protein, which is also a subject of the present invention.

It has in fact been noted that the preparation process described above, and in particular the presence of the steps of reducing and raising the pH, promotes the formation of assemblies between the plant protein and the milk protein. The assembly of at least one plant protein and of at least one milk protein thus obtained differs from simple physical mixing of these two types of proteins. A new structure on the supramolecular scale is involved.

Said assembly may be in the form of an aqueous composition, of a concentrated aqueous composition or of a powder. In the case of an aqueous composition, the term aqueous dispersion is instead used.

An aqueous composition, or an aqueous dispersion, comprising the assembly of at least one plant protein and of at least one milk protein is obtained at the end of the process which is the subject of the present invention. This aqueous composition or dispersion has a pH of preferably between 5 and 8, more preferentially between 5.5 and 7.5, and even more preferentially between 5.8 and 7.1.

The weight ratio of plant protein to milk protein in the assembly according to the invention is between 20:80 and 45:55, and preferably is 40:60.

Preferably, the (weight of nitrogenous matter provided by the composition comprising at least one plant protein) to (weight of nitrogenous matter provided by the composition comprising at least one milk protein) ratio is between 99:1 and 1:99, more preferentially between 80:20 and 20:80, even more preferentially between 65:35 and 35:65.

In the above ratio, the respective weights of total proteins are measured by the method by assaying the soluble nitrogenous fraction contained in the sample according to the Kjeldahl method. The total protein content is then obtained by multiplying the nitrogen content, expressed as percentage by weight of dry product, by the factor 6.25. This method is well known to those skilled in the art.

The total content of proteins of the composition is preferably between 20% and 100% by weight of dry product, more preferentially between 30% and 90%, even more preferentially between 35% and 85%, and in particular between 40% and 80%.

Said contents are indicated as weight percentage of dry product relative to the total dry weight of the composition.

According to another embodiment, the protein content of the composition is between 50% and 90% by weight of dry product.

When the assembly according to the invention is in the form of an aqueous dispersion, i.e. when the assembly is suspended in a liquid, the protein content is indicated as concentration by weight, i.e. as weight concentration, which expresses the ratio between the mass of a solute, i.e. the proteins, and the volume of aqueous dispersion.

The assembly comprising at least one plant protein and at least one milk protein according to the invention may optionally comprise other ingredients. These optional ingredients may have advantageous properties for certain applications. They may be chosen from the group consisting of soluble fibers, insoluble fibers, vitamins, mineral salts, trace elements, and mixtures thereof. The optional ingredients may be provided by the composition comprising at least one plant protein or at least one milk protein, or they may be added during the preparation of the assembly.

The assembly according to the invention may in addition contain any appropriate additive, for instance flavorings, dyes, stabilizers, excipients, lubricants and preservatives, provided that they do not negatively affect the final functional properties desired. They may be pharmaceutical or phytosanitary active ingredients, or detergents. In the present invention, the term “active ingredient” is intended to mean any active molecule which has a demonstrated pharmacological effect and a therapeutic advantage, which has also been clinically demonstrated.

A subject of the present invention is also an assembly of at least one milk protein and of at least one plant protein, which can be obtained according to the production process described in the present application.

The assembly of at least one milk protein and of at least one plant protein according to the invention has an application in various industrial sectors, and more particularly in the food-processing field.

The assembly which is the subject of the invention in fact has functional and/or sensory properties that are different than those of the simple physical mixture of plant proteins and milk proteins. In particular, this assembly has at least one of the following functional properties:
an improved solubility;
an improvement in the holding in suspension;
an improved coagulating capacity;
   compared with the simple physical mixture of plant proteins and milk proteins. A synergistic effect on the functional properties is consequently observed with the assembly according to the invention. Synergy commonly reflects a phenomenon by which several participants, factors or influences acting together create an effect that is greater than the sum of the expected effects if they had occurred independently, or create an effect that each of them would not have been able to obtain by acting in isolation. In the present application, the word is also used to denote a result that is more favourable when several elements of a system act in concert.

In the context of the present invention, the synergy reflects the existence of an intimate mixture between the various components of the assembly, the fact that the distribution thereof in the assembly is substantially homogeneous, and the fact that they are not solely linked to one another by a simple physical mixture.

The assembly of at least one milk protein and of at least one plant protein according to the invention is a ubiquitous phenomenon which can result in the formation of a variety of supramolecular structures. These supramolecular structures can differ from one another by virtue of their size (from a few nanometers to several micrometers), their protein composition and their morphology (aggregates, fibers, nanotubes, etc.). These assemblies intervene in the functionality of these proteins (gelling, foaming and emulsifying capacity; vector of bioreactive molecules, etc.). Several factors are capable of influencing the nature of these supramolecular structures. They may be of a nature extrinsic to proteins, for instance the physicochemical parameters of the medium, or else of a nature intrinsic to proteins. These intrinsic factors, linked to their stability and to the degree of exposure of the various electrostatic and hydrophobic regions of the protein, are themselves frequently modulated by the physicochemical parameters of the medium.

Proteins are polyelectrolytes characterized by a conformational diversity, and a heterogeneous distribution of charges and of hydrophobic regions at their surface. They therefore appear to be heterogeneous and complex polyelectrolytes. These various factors intrinsic to proteins consequently explain the diversity and complexity of the behaviors encountered during their assembly, thereby distinguishing them from the assembly of synthetic colloids with monomeric structures and with physicochemical properties that are more uniform and therefore easier to control.

Today, the role played by the confirmation of proteins in the formation of protein assemblies has clearly been demonstrated. The formation of protein assemblies from globular proteins frequently requires an at least partial modification of their three-dimensional structure. Indeed, the globular protein assembly properties are increased under physicochemical conditions where the globular proteins have a certain degree of unfolding generally resulting in exposure of hydrophobic regions to the solvent. The modification of protein conformation is usually carried out by adjusting the physicochemical conditions of the medium.

The applicant companies have carried out laser particle size analysis measurements on the assemblies according to the present invention in order to verify whether there is an impact of the various treatments on the size of the particles of the assembly compared with the size of the particles of plant proteins taken alone and that of milk proteins also taken alone.

The principle of this measurement is given hereinafter in the examples and also the measurement curves.

What emerges from these various measurements is that, when they are carried out on the starting proteins, it is noted that the plant proteins, and more particularly pea proteins, are approximately 10 times larger than the milk proteins when they are taken separately. When they are assembled (60/40 milk/pea ratio), the peak corresponding to the milk proteins is no longer visible, which can imply that the two types of proteins are rearranged according to a molecular process.

The applicant companies have noted that the very advantageous functional properties of the assembly of at least one milk protein and of at least one plant protein according to the invention cannot be obtained if each compound is used separately or if the compounds are used simultaneously but in the form of a simple mixture of the various constituents.

In addition, the assembly according to the invention can have advantageous functional properties, in particular:
an emulsifying capacity;
a foaming capacity;
a gelling capacity;
a thickening capacity;
a viscosifying capacity;
an overrun capacity;
a wetting capacity (water absorption capacity);
a film-forming and/or adhesive capacity;
a thermal reactivity capacity;
a capacity in Maillard reactions.

A subject of the invention is thus the use of the assembly according to the invention as a functional agent, and preferably as an emulsifying agent, foaming agent, gelling agent, thickener, viscosifying agent, overrun agent, water-retaining agent, film-forming and/or adhesive agent, agent having a capacity in Maillard reactions, and an agent for modifying the sensory properties of the food matrices in which it is used.

Another subject of the invention is the use of the assembly according to the invention for preparing a food composition. This food composition can be chosen from the group consisting of beverages, milk products, confectionery products such as chocolates, milk desserts, preparations intended for clinical nutrition and/or for individuals suffering from undernourishment, preparations intended for infant nutrition, mixtures of powders intended for diet products or for sportspersons, high-protein products for dietetic nutrition, soups, sauces and culinary aids, confectionery products, for instance chocolate and all the products derived from the latter, meat-based products, more particularly in the fine paste and brine sectors, in particular in the production of hams and cooked pork meats, fish-based products, such as surimi-based products, cereal products such as bread, pasta, cookies, pastries, cereals and cereal bars, vegetarian products, including fermented products based on plant proteins, for instance tofu, ready meals, whitening agents such as coffee whiteners, products intended for feeding animals, for instance products intended for feeding calves. Preferably, the food composition is chosen from the group consisting of milk products and even more preferentially from the group consisting of fromage frais and ripened cheeses, cheese spreads, fermented milks, milk smoothies, yoghurts, specialty milk products and ice creams produced from milk.

It has also been observed, unexpectedly, that, in the food sector for example, the assembly according to the present invention has the additional advantage of totally or partially replacing the fats commonly used in recipes, without having an impact on the final sensory and textural properties.

In one advantageous embodiment, the food composition is therefore a low-fat food composition.

The food composition may also be enriched with proteins.

According to one advantageous embodiment, the food composition is a chocolate. It is in fact possible to prepare a chocolate with a reduced milk protein and/or fat content by replacing the milk proteins initially present with an assembly of at least one milk protein and of at least one plant protein according to the invention.

In one preferred embodiment, the assembly used in the preparation of the chocolate is characterized in that the plant protein is a pea protein and the milk protein is a casein. Despite the fact that pea proteins and milk proteins have very different compositions, the total replacement of the milk proteins with an assembly of at least one milk protein and of at least one plant protein in a chocolate modifies neither the appearance, nor the feel, nor the odor, nor the taste, nor the texture of the latter.

In particular, the chocolates obtained comprising the assembly according to the invention retain:
in terms of appearance: a smooth and shiny surface,
in terms of odor: a soft, fruity and very pleasant odor,
in terms of taste: a smoothness, a fullness in the mouth and a creamy aspect, these characteristics being desired and highly appreciated by those who eat chocolate.

From a technological point of view, this total or partial replacement of the milk proteins with pea proteins does not significantly modify the rheological behavior of the preparations which are used. The rheological behavior can be quantified by two measurements: the viscosity value and the yield point value. In the food-processing field of confectionery products and therefore of chocolate, the theoretical model generally used is the Casson model. Since the behavior of the chocolates during their production is not modified, there will not therefore be any need to modify the parameters of the production process.

Another particularly advantageous and valuable use of the present invention relates to the production of a milk product chosen from the group consisting of fromage frais and ripened cheeses, cheese spreads, fermented milks, milk smoothies, yoghurts, specialty milk products and ice creams produced from milk.

Thus, the present invention advantageously relates to a process for preparing a milk product chosen from the group consisting of fromage frais and ripened cheeses, cheese spreads, fermented milks, milk smoothies, yoghurts, milk specialty products and ice creams produced from milk, characterized in that the milk proteins initially present are replaced with an assembly of at least one milk protein and of at least one plant protein obtained according to the process of the present invention.

In one preferred embodiment, the assembly used in the preparation of the milk product above is characterized in that the plant protein is a pea protein and the milk protein is a casein.

According to another more preferential mode, the assembly according to the invention is used for the production of cheeses.

Thus, the present invention advantageously relates to a process for preparing a cheese, characterized in that the milk proteins initially present are replaced with an assembly of at least one milk protein and of at least one plant protein obtained according to the process of the present invention.

In one preferred embodiment, the assembly used in the preparation of cheeses is characterized in that the plant protein is a pea protein and the milk protein is a casein.

In the present invention, the term “cheese” denotes a food obtained from coagulated milk or from milk products, such as cream, then optionally draining, optionally followed by a fermentation step and optionally ripening (ripened cheeses). According to French decree No. 2007-628 of Apr. 27, 2007, the name “cheese” is reserved for the fermented or non-fermented, ripened or non-ripened product obtained from materials of exclusively milk origin (whole milk, partially or totally skimmed milk, cream, fat, buttermilk), used alone or as a mixture, and totally or partially coagulated before draining or after partial elimination of their water.

In the present invention, the term “cheese” also denotes all processed cheeses and all processed cheese spreads. These two types of cheeses are obtained by milling, mixing, melting and emulsification, under the effect of heat and emulsifiers, of one or more varieties of cheese, with or without the addition of milk constituents and/or of other food products (cream, vinegar, spices, enzymes, etc.).

In another preferential mode, the assembly according to the invention is used for the production of yoghurts or fermented milks.

Thus, the present invention advantageously relates to a process for preparing a yoghurt or a fermented milk, characterized in that the milk proteins initially present are replaced with an assembly of at least one milk protein and of at least one plant protein obtained according to the process of the present invention.

In one preferred embodiment, the assembly used in the preparation of yoghurts or fermented milks is characterized in that the plant protein is a pea protein and the milk protein is a casein.

In the present invention, the replacement of the milk proteins initially present may be total or partial. The invention will be understood more clearly on reading the examples which follow, which are intended to be illustrative while referring only to certain embodiments and certain advantageous properties according to the invention, and nonlimiting.

### EXAMPLES

### Example 1: Preparation of the Various Assemblies Used

### A. Raw Materials

### Milk Proteins:

The milk proteins used are derived from a milk fraction and contain 92% of micellar caseins relative to the total nitrogenous matter.

It may for example be the micellar casein retentate Promilk 852 B sold by the company Ingredia, which is in liquid form (retentate containing 15% of solids), stabilized by addition of 0.02% of bronopol (preservative), and stored at 4° C.

### Plant Proteins:

### Information Regarding the Pea Fractionation Process

The pea contains approximately 27% by weight of protein matter. Among the constituents of the pea, those currently most exploited are starch, fibers and proteins, also referred to as noble constituents. The exploitation process consists in initially preparing a starch milk, by mixing the pea flour and water in a kneading machine. After having extracted the starch and the fibers from this milk, a protein-rich product is obtained. A flocculation step is then carried out on the milk, in particular by thermocoagulation, the objective of which is to make the protein(s) of interest insoluble. At this stage of the process, it is necessary to perform a separation in particular by centrifugal decanting, so as to isolate a composition very rich in proteins, also called “floc”.

The examples were carried out with a protein-rich pea milk on which the following steps were carried out, so as to obtain in the end a pea protein floc:

Reduction of the pH and precipitation at the isoelectric point at pH 4.5 with 1 N HCl with stirring at 500 rpm of the pea milk.
Dissolution with stirring at 500 rpm with a magnetic bar at 4° C. for 2 hours.
Raising of the pH to neutrality with 1 N sodium hydroxide.
Stirring of the assembly at 500 rpm with a magnetic bar for 30 minutes.
Stabilization of the mixture also called flocculate of pea proteins by addition of sodium azide at 0.02%.

### Storage at 4° C.

### B. Mixing Process: Forming of the Assemblies

The composition of milk proteins is in a liquid form and naturally has a pH of 7.

The composition of pea proteins or pea protein flocculate is also in a liquid form and also has, after acidification and then neutralization, a pH of 7.

### Test 1: 80/20 (Milk Proteins/Plant Proteins) Assembly

Preparation of a solution of pea proteins in water at 32 g/l of TNM maintained at 4° C. and with stirring for 1 hour.
Preparation of a solution of milk proteins in water at 128 g/l of TNM maintained at 4° C. and with stirring for 1 hour.
Mixing of the two protein solutions in a 50/50 (v/v) proportion.
Maintaining at 4° C. and with stirring for 1 hour.
Instant pasteurization at 80° C. (2.7 bar).
Evapoconcentration to 23% of DM.
Homogenization at 300 bar.
Spray-drying according to a feasibility scale determined by those skilled in the art.

### Test 2: 60/40 (Milk Proteins/Plant Proteins) Assembly

Preparation of a solution of pea proteins in water at 64 g/l of TNM and stirring for 1 hour.
Preparation of a solution of milk proteins in water at 98 g/l of TNM and stirring for 1 hour.
Mixing of the two protein solutions in a 50/50 (v/v) proportion.
Maintaining at 4° C. and with stirring for 1 hour.
Evapoconcentration to 23% of DM.
Homogenization at 300 bar.
Spray-drying.

### Test 3:

Assembly identical to that described in test 2, but on which an HTST treatment was applied to the pea protein flocculate, after neutralization and before mixing thereof with the composition of milk proteins. This is subsequently assembly 3.

### Example 2: Characterization of the Various Functional Properties and/or Technologies of the Assemblies Obtained According to Example 1

| | | Simple 60/40 | | | |
|---|---|---|---|---|---|
| Criterion | Unit | dry mixture | Test 1 | Test 2 | Test 3 |
| Dry matter | % | | | 93.5 | 93.2 |
| Protein content | %/dry | | | 84.3 | 85.2 |
| Solubility 5000G | % | | | 85.2 | 89.0 |
| Viscosity in | mPa · s | | | 67 | 160 |
| solution at 15%, | | | | | |
| 40 s⁻¹ | | | | | |
| Emulsifying | μm | | 24.8 | 24.4 | 20.2 |
| capacity (Dmode) | | | | | |
| Emulsion stability | μm | | | 35.6 | 29.1 |
| (D90-D10) | | | | | |
| Gel test at 4° C. | mPa · s | 2.400 | | 15.000 | |
| Post-pasteurization | mPa · s | 200 | | 10.040 | |
| gel test | | | | | |
| Post-sterilization | mPa · s | 1.040 | | 180 | |
| gel test | | | | | |
| Emulsion test at | mPa · s | 380.000 | | 730.000 | |
| 4° C. | | | | | |
| Post-pasteurization | mPa · s | 430.000 | | 960.000 | |
| emulsion test | | | | | |
| Post-sterilization | mPa · s | 330.000 | | 928.000 | |
| emulsion test | | | | | |
| Gelling test | N | | 1.2 | 0.43 | |

In order to determine the amount of proteins in the various samples, the soluble nitrogenous fraction contained in the sample can be assayed according to the Kjeldahl method (NF V03-050, 1970). The determination of ammoniacal nitrogen is based on the formation of a colored complex between the ammonium ion, sodium salicylate and chlorine, the color intensity of which is measured at 660 nm. This method is performed with a Technicon continuous liquid flow automatic device.

The protein content of the samples is estimated by multiplying their nitrogen content by the conversion factor 6.25.

This method is well known to those skilled in the art.

In order to determine the soluble protein content, the content of proteins soluble in water of which the pH is adjusted to 7.5+/−0.1 using a solution of HCl or NaOH is measured by means of a method of dispersion of a test specimen of the sample in distilled water, centrifugation and analysis of the supernatant. 200.0 g of distilled water at 20° C.+/−2° C. are placed in a 400 ml beaker and the whole is stirred magnetically (magnetic bar and rotation at 200 rpm). Exactly 5 g of the sample to be analyzed are added. The mixture is stirred for 30 min and centrifuged for 15 min at 4000 rpm. The method for determining nitrogen is carried out on the supernatant according to the method previously described.

### Example 3: Measurement of the Particle Size by Laser Particle Size Analysis

Dynamic light scattering or DLS is a nondestructive spectroscopic analysis technique which makes it possible to obtain the size of particles in suspension in a liquid or of polymer chains in solution, having a diameter approximately from 1 to 500 nm.

It is possible to measure the intensity of the light scattered by the particles at a considered angle (typically 90°) over time. This time-dependency comes from the fact that the particles in a liquid are subjected to Brownian motion because of thermal agitation.

DLS results in the measurement of the hydrodynamic radii of the particles and polymers. The hydrodynamic radius is the radius of a theoretical sphere that would have the same scattering coefficient as the particle under consideration. For a charged particle, the sphere considered contains the particle surrounded by its diffuse layer. In reality, there is a dispersity of the sizes encountered, and various methods are carried out in order to extract the scattered intensity of the various populations.

The differences are very marked in terms of intensity and the presence of impurities or aggregates are very visible, even in very small number.

A hydrodynamic radius, a polydispersity index and indications regarding the appearance of the particle size distribution profile of the sample, in number, volume or intensity, are thus obtained.

For these measurements, tests 2 and 3 as described in example 1 were used.

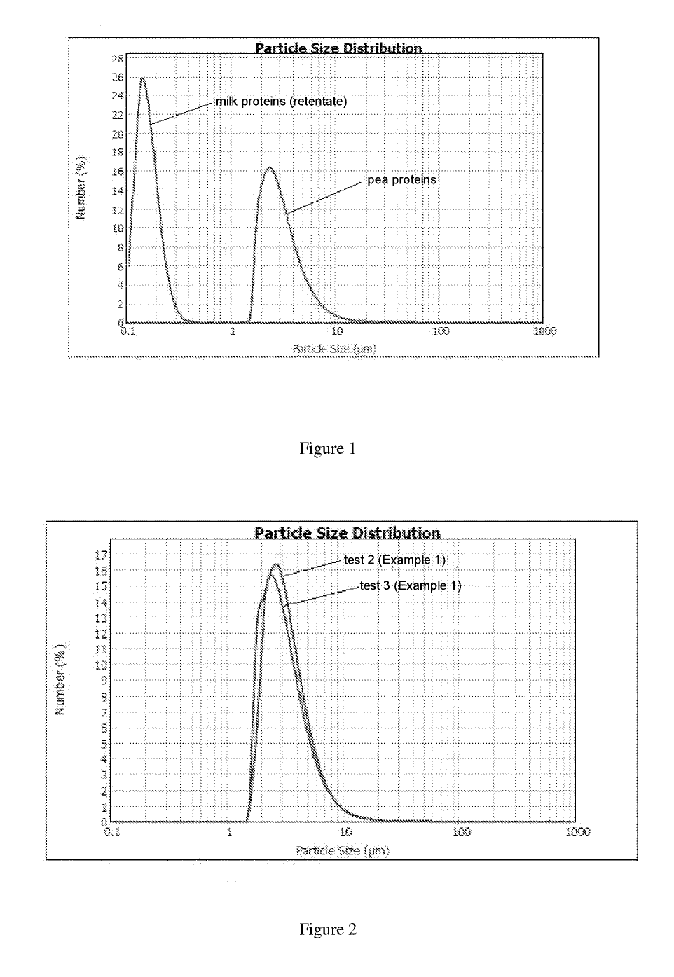

The first series of curves, represented in FIG. 1, corresponds to the size distribution of the pea proteins and of the milk proteins alone, and the second series of curves, represented in FIG. 2, corresponds to the size distribution of the assemblies according to the invention (test 2 of example 1) and said assemblies having undergone HTST treatment (test 3 of example 1).

In FIG. 1, the curve located the furthest to the left on the graph corresponds to the size distribution carried out on the milk proteins, and the curve located furthest to the right corresponds to measurements carried out on a pea protein flocculate. Taken separately, the pea proteins are approximately ten times larger than the milk proteins.

Examining the second series of curves, represented in FIG. 2, it is realised that the peak corresponding to the milk proteins that is visible on the first series of curves with a culminating point at 0.105 μm is no longer visible.

This implies that the proteins have become rearranged with one another during the preparation of the assemblies according to the invention.

If there had only been simple mixing or juxtaposition of the two types of proteins, two peaks would have been found on each curve, each corresponding to the type of protein. Finding only one single peak perfectly demonstrates that the two types of proteins have become rearranged with one another at the molecular level.

### Example 4: Use of the Assemblies Obtained According to Example 1 in the Preparation of Milk Chocolate with a Reduced Milk Protein Content and/or Reduced Fat Content

The objective of this test is to use the assemblies of the present invention in order, firstly, to reduce the milk proteins present in the chocolate and, secondly, to also reduce the fat content in a milk chocolate recipe, while at the same time not modifying the process for preparing the chocolate.

### A. Reduction in the Amount of Milk Proteins

Two controls were carried out.

The first contains a final content of 32% fat and the second 30%, the percentages being expressed per 100 g of final product.

For this test, assemblies 2 and 3 obtained according to example 1 were used. For assembly 2, the ratio is therefore 60/40 (milk proteins/plant proteins) and for assembly 3, the protein ratio is the same, but with a final HTST treatment applied.

### Formulae

| | | Assem- | Assem- |
|---|---|---|---|
| | Control | bly 2 | bly 3 |
| | 32% Fat | (32% Fat) | (32% Fat) |
| | % | % | % |
| Granulated sugar | 44.00 | 46.10 | 46.10 |
| Cocoa liquor | 10.00 | 10.00 | 10.00 |
| Cocoa butter | 20.70 | 18.60 | 18.60 |
| Anhydrous milk fat | 0.00 | 5.35 | 5.35 |
| Assembly 2 | 0.00 | 7.10 | 0.00 |
| Assembly 3 | 0.00 | 0.00 | 7.10 |
| Lactose monohydrate | 0.00 | 7.75 | 7.75 |
| Whole milk powder (spray) | 20.20 | 0.00 | 0.00 |
| Whey powder | 4.50 | 4.50 | 4.50 |
| Soy lecithin | 0.60 | 0.60 | 0.60 |
| Total | 100.00 | 100.00 | 100.00 |
| | | Assem- | Assem- |
| | Control | bly 2 | bly 3 |
| | 30% Fat | (30% Fat) | (30% Fat) |
| | % | % | % |
| Granulated sugar | 46.10 | 46.10 | 46.10 |
| Cocoa liquor | 10.00 | 10.00 | 10.00 |
| Cocoa butter | 18.60 | 20.70 | 20.70 |
| Anhydrous milk fat | 0.00 | 3.25 | 3.25 |
| Assembly 2 | 0.00 | 7.10 | 0.00 |
| Assembly 3 | 0.00 | 0.00 | 7.10 |
| Whole milk powder (spray) | 20.20 | 0.00 | 0.00 |
| Whey powder | 4.50 | 4.50 | 4.50 |
| Lactose monohydrate | 0.00 | 7.75 | 7.75 |
| Soy lecithin | 0.60 | 0.60 | 0.60 |
| | 100.00 | 100.00 | 100.00 |

No manufacturing hitch, in particular during the conching step, was noted.

The chocolates were tasted blind by a jury of sensory analysis experts made up of 25 individuals. The test carried out blind consisted in tasting the three samples for each fat content and in describing them. Tasting is an operation which consists in testing, analyzing and assessing the organoleptic characteristics and more particularly the organo-olfactory characteristics of a product. Tasting calls upon the visual, tactile, olfactory and gustative senses. For this tasting, the descriptions used were identical for the three chocolates:
Observation test: surface of the chocolate smooth, marbled and slightly shiny.
Tactile test: smooth, hard surface.
Olfactory test: sweet, fruity, very pleasant odor.
Gustative test: smoothness, fullness in the mouth, creamy.

There was therefore no impact regarding the replacement of the milk proteins present in the chocolate with an assembly between a pea protein and a milk protein obtained according to the invention.

There is therefore also no impact in this food matrix of the HTST treatment of said assembly.

### B. Reduction in the Amount of Fat

Two fat reduction tests (at 28% and 26%) were carried out using assembly 2 obtained according to example 1.

### Formulae

| | Assembly 2 | Assembly 2 |
|---|---|---|
| | (28% Fat) | (26% Fat) |
| | % | % |
| Granulated sugar | 48.10 | 50.10 |
| Cocoa liquor | 10.00 | 10.00 |
| Cocoa butter | 20.70 | 18.95 |
| Anhydrous milk fat | 1.25 | 1.00 |
| Lactose monohydrate | 7.75 | 7.75 |
| Whole milk powder | 0.00 | 0.00 |
| Whey powder | 4.50 | 4.50 |
| Assembly 2 | 7.10 | 7.10 |
| Soy lecithin | 0.60 | 0.60 |
| Total | 100.00 | 100.00 |

The two samples of milk chocolate with a reduced fat content prepared with the assembly were compared with the control chocolate at 32% fat during a blind tasting with a jury of sensory analysis experts made up of 25 individuals.

The test carried out blind consisted in tasting the three samples and in describing them. Tasting is an operation which consists in testing, analyzing and assessing the organoleptic characteristics and more particularly the organo-olfactory characteristics of a product. Tasting calls upon the visual, tactile, olfactory and gustative senses. For this tasting, the descriptions used were identical for the three chocolates:
Observation test: surface of the chocolate smooth, marbled and slightly shiny.
Tactile test: smooth, hard surface.
Olfactory test: sweet, fruity, very pleasant odor.
Gustative test: smoothness, fullness in the mouth, creamy.

There was therefore no impact regarding the replacement of the milk proteins present in the chocolate with an assembly between a pea protein and a milk protein obtained according to the invention.

This makes it possible in particular to obtain a chocolate which has a reduced fat content while at the same time having no impact on its final organoleptic characteristics.

### Example 5: Use of the Assemblies Obtained According to Example 1 in the Preparation of a Full-Fat Stirred Yoghurt

The objective of this test is to replace a part of the milk proteins conventionally used (Promilk 852B) with assembly 2 of example 1, by testing three substitution percentages: 25%, 50% and 75%.

### Formulae

| | CONTROL | | | |
|---|---|---|---|---|
| | Promilk | Assem- | Assem- | Assem- |
| | 852B | bly 2 | bly 2 | bly 2 |
| | 100% | 25% | 50% | 75% |
| Liquid skimmed milk | 90.6 | 90.61 | 90.59 | 90.35 |
| Cream (42%) | 7.79 | 7.79 | 7.79 | 7.79 |
| Promilk 852B | 1.6 | 1.2 | 0.81 | 0.43 |
| Assembly 2 | — | 0.4 | 0.81 | 1.23 |
| Solids extract (%) | 13.3 | 13.3 | 13.3 | 13.3 |
| TNM (%) | 4.5 | 4.5 | 4.5 | 4.5 |
| Fat (%) | 3.5 | 3.5 | 3.5 | 3.5 |
| Syneresis | Yes | Weak | Weak | Weak |
| Drying, powdery | Nothing to | Nothing to | Nothing to | Nothing to |
| | Report | Report | Report | Report |
| Creaminess | + | + | ++ | ++ |

This example demonstrates that it is possible to replace the milk proteins with the assembly according to the invention, this being the case for the three substitution percentages tested.

From a sensory and organoleptic point of view, the three yoghurts tested were judged to be very acceptable compared with the control yoghurt.

Starting from a degree of substitution of 50%, the yoghurts obtained are even graded as being more creamy, which may constitute an advantageous marketing position.

It is also noted that the syneresis phenomenon is reduced once an assembly is used in the recipe.

### Example 6: Use of the Assemblies Obtained According to Example 1 in the Preparation of a Cheese Analog

The objective of this test is to replace a part of the milk proteins conventionally used (Promilk 852B) with assembly 2 of example 1, by testing three substitution percentages: 20%, 40% and 60% in a cheese analog recipe.

### Formulae

| | CONTROL | | | |
|---|---|---|---|---|
| | Promilk | Assem- | Assem- | Assem- |
| | 852B | bly 2 | bly 2 | bly 2 |
| | 100% | 20% | 40% | 60% |
| Water | 46.30% | 46.30% | 46.30% | 46.30% |
| Anhydrous milk fat | 25.00% | 25.00% | 25.00% | 25.00% |
| Emulsifying salts | 1.80% | 1.80% | 1.80% | 1.80% |
| Promilk 852B | 25.00% | 20.00% | 15.00% | 10.00% |
| Assembly 2 | — | 5.00% | 10.00% | 15.00% |
| Salt | 1.50% | 1.50% | 1.50% | 1.50% |
| Citric acid | 0.40% | 0.60% | 0.60% | 0.60% |
| Solids extract (%) | 52.30% | 52.30% | 52.30% | 52.30% |
| TNM (%) | 20.20% | 20.20% | 20.20% | 20.20% |
| Fat/Solids extract | 48.20% | 48.20% | 48.20% | 48.20% |
| Production/ | Not very | Uniform, | Uniform, | Uniform, |
| Exiting kneading | uniform, | beige, fat | beige, fat | beige, fat |
| machine | tacky, fat | exudation | exudation | exudation |
| | exudation | | | |
| pH exiting | 5.61 | 5.59 | 5.68 | 5.68 |
| kneading machine | | | | |

### Sensory Analysis

| | CONTROL | | | |
|---|---|---|---|---|
| | Promilk | Assem- | Assem- | Assem- |
| | 852B | bly 2 | bly 2 | bly 2 |
| | 100% | 20% | 40% | 60% |
| Promilk | 25.00% | 20.00% | 15.00% | 10.00% |
| 852B | | | | |
| Assembly 2 | — | 5.00% | 10.00% | 15.00% |
| Appearance | Firm, plastic | Slice (−) | Slight | Greater |
| | | smooth, | loss of | loss of |
| | | quite firm | firmness | firmness, shiny |
| | | | | & tacky |
| Tasting | | Acceptable | Acceptable | Unacceptable |
| | | pea note | pea note | pea note |

It is therefore possible to replace up to 40% of the milk proteins initially present with a 60/40 (milk proteins/plant proteins) assembly in a cheese analog recipe without significantly affecting the final characteristics of the product.

### Example 7: Use of the Assemblies Obtained According to Example 1 in the Preparation of a Fromage Frais without Separation (GDL FETA)

The objective of this test is to replace a part of the milk proteins conventionally used (Promilk 852B) with assembly 2 of example 1, by testing three substitution percentages: 25%, 50% and 75% in a recipe for fromage frais without separation, of GDL (gluconodeltalactone) feta type.

### Formulae

| | CONTROL | | | |
|---|---|---|---|---|
| | Promilk | Assem- | Assem- | Assem- |
| | 852B | bly 2 | bly 2 | bly 2 |
| | 100% | 25% | 50% | 75% |
| Water | 59.10% | 59.10% | 59.10% | 59.10% |
| Vegetable fat | 18.00% | 18.00% | 18.00% | 18.00% |
| SMP | 10.30% | 10.30% | 10.30% | 10.30% |
| Promilk 852B | 7.60% | 5.70% | 3.80% | 1.90% |
| Assembly 2 | — | 1.90% | 3.80% | 5.70% |
| Salt | 2.00% | 2.00% | 2.00% | 2.00% |
| GDL | 3.00% | 3.00% | 3.00% | 3.00% |
| Solids extract | 18.20% | 18.20% | 18.10% | 18.10% |
| (%) | | | | |
| TNM (%) | 9.60% | 9.60% | 9.50% | 9.40% |
| Fat/Solids | 45% | 45% | 45% | 45% |
| extract | | | | |

### Sensory Analysis

| | | | | |
|---|---|---|---|---|
| Texture | Crumbly, | Quite | Quite | Very |
| upon | firm | crumbly, | crumbly, +moist/ | spreadable, |
| tasting | | but <100% | F2, | moist |
| Creaminess | + | ++ | +++ | +++ |
| Taste | Acid, | acid | Slight but | Not |
| | lactic | | acceptable | very acid, |
| | | | “pea” note | quite marked |
| | | | | “pea” note |
| Market | Block feta | Block feta | Feta spread | — |
| referent | | | | |

It is therefore possible to replace up to 50% of the milk proteins initially present with a 60/40 (milk proteins/plant proteins) assembly in a recipe for fromage frais without separation without significantly affecting the final characteristics of the product.

### Example 8: Use of the Assembly Obtained According to Example 1 in the Preparation of a UHT High-Protein Cream Dessert

The objective of this test is to replace a part of the proteins normally used in formulations of this type (Prodiet 87B) with assemblies 2 and 3 of example 1.

In parallel, a test was also carried out by replacing the proteins normally used with a simple dry physical mixture between a composition of pea proteins and a composition of milk proteins identical to those used in example 1, but without any conformation modification treatment.

### Formulae

| | | | | Milk protein/ |
|---|---|---|---|---|
| | | | | plant protein |
| | | Assem- | Assem- | dry mixture |
| | Control | bly 2 | bly 3 | (60/40 ratio) |
| Water | 80.32% | 79.62% | 79.62% | 79.62% |
| UHT CREAM | 2.00% | 2.00% | 2.00% | 2.00% |
| 30% Fat | | | | |
| Grated chocolate | 0.50% | 0.50% | 0.50% | 0.50% |
| Cocoa powder | 2.50% | 2.50% | 2.50% | 2.50% |
| Salt/Sweetener | 1.67% | 1.67% | 1.67% | 1.67% |
| Hydrocolloids | 1.80% | 1.80% | 1.80% | 1.80% |
| Sucralose | 0.010% | 0.010% | 0.010% | 0.010% |
| Prodiet 87B low | 11.2% | | | |
| calcium | | | | |
| Assembly 2 | | 11.9% | | |
| Assembly 3 | | | 11.9% | |
| Milk protein/plant | | | | 11.9% |
| protein dry mixture | | | | |

The creams obtained were tasted blind by a trained jury made up of 25 individuals. Those produced with the assemblies were judged to be identical to the control and satisfactory in terms of texture in the mouth, creaminess and smoothness.

On the other hand, the cream produced with the simple dry mixture was judged to be unacceptable since it did not have the creamy texture expected for this type of product.

Thus, using an assembly which has undergone a treatment to modify the conformation of the proteins makes it possible to obtain technological characteristics that the simple physical mixture of the two protein compositions does not have.

### Example 9: Use of the Assembly Obtained According to Example 1 in the Preparation of a Milk Mousse

The objective of this test is to replace all of the milk referent conventionally used in a milk mousse recipe with assembly 2 of example 1.

### Formulae

| | Control | Assembly 2 |
|---|---|---|
| Water | 62.20% | 62.20% |
| Vegetable fat | 8.90% | 8.90% |
| Sugar | 11.20% | 11.20% |
| Cocoa powder + chocolate | 7.00% | 7.00% |
| Systems for texturing + dairy | 9.77% | 9.77% |
| Milk referent | 0.93% | — |
| Assembly 2 | — | 0.93% |
| Viscosity before whipping^{t} | 74000 | 96400 |
| (mPa · s⁻¹, R7 20 rpm) | | |
| Overrun (%) | 127 | 127 |

This example illustrates that it is possible to produce milk mousses with an assembly of proteins containing pea proteins and milk proteins. The process for producing said mousses is not affected by the use of this assembly in the formulation.

The product exhibits excellent overrun and the final texture of the product was judged to be identical to that of the control.

Thus, the advantage of the assemblies according to the invention and their role as a texturing agent, and more particularly overrun agent, is perfectly demonstrated here.

### Example 10: Use of the Assembly Obtained According to Example 1 in the Preparation of Ice Cream

The objective of this test is to replace a part of the milk proteins normally used in the formulation of ice cream with assembly 2 of example 1.

### Formulae

| Ingredients | Control | Assembly 2 |
|---|---|---|
| Water | 48.9 | 49.2 |
| Crème fraîche (36% fat) | 25.0 | 25.0 |
| Sucrose | 12.0 | 14.0 |
| Skimmed milk powder | 5.0 | 1.0 |
| Assembly 2 | 0.0 | 1.7 |
| Whey powder | 4.0 | 4.0 |
| Glucose syrup | 4.0 | 4.0 |
| Stabilizer | 0.6 | 0.6 |
| IFF Vanilla flavoring | 0.5 | 0.5 |
| Masking flavoring | 0.0 | Qs |
| | 100.0 | 100.0 |

### Analysis of the Ice Creams Obtained

| Nutritional values | | |
|---|---|---|
| per 100 g | Control | Assembly 2 |
| Energy (Kcal) | 181.0 | 180.0 |
| Proteins (g) | 3.0 | 3.0 |
| Carbohydrates (g) | 22.2 | 21.6 |
| Of which sugars (g) | 21.1 | 20.8 |
| Lipids (g) | 9.1 | 9.0 |
| Dry matter | 34.8 | 35.5 |

The two ice cream samples were tasted blind by a jury of sensory analysis experts made up of 25 individuals.

The first test consisted of a triangular test in which, of the three samples proposed, two were identical.

70% of the individuals who participated in the test were not able to recognize which of the samples were the two identical ones. None of the samples tested received a significant preference from the jury.

The second test, still carried out blind, consisted in tasting the two samples and in describing them. Tasting is an operation which consists in testing, analyzing and assessing the organoleptic characteristics and more particularly the organo-olfactory characteristics of a product. Tasting calls upon the visual, olfactory and gustative senses. For this tasting, the descriptions used were identical for the two ice creams:
Observation test: surface of the ice cream smooth.
Olfactory test: very pleasant, sweet, milky, vanilla odor.
Gustative test: smoothness, fullness in the mouth, creamy.

No difference, either in terms of texture or in terms of taste, could be demonstrated between the two ice creams.

### Example 11: Use of the Assembly Obtained According to Example 1 in the Preparation of a Protein-Rich Instant Soup

The objective of this test is to produce a preparation for a protein-rich instant soup using assembly 2 of example 1. The control, for its part, was carried out using a simple dry physical mixture between a composition of pea proteins and a composition of milk proteins identical to those used in example 1, but without any conformation modification treatment.

### Formulae

| | Dry mixture | Assembly 2 |
|---|---|---|
| Mushroom powder | 20.0 | 20.0 |
| Dry mixture | 30.0 | 0.0 |
| Glucose syrup | 13.7 | 13.7 |
| Assembly 2 | 0 | 30.0 |
| Soup creamer (refined palm oil, lactose, | 10.0 | 10.0 |
| caseinate) | | |
| Modified potato starch | 9.4 | 9.4 |
| Soluble wheat protein | 3.75 | 3.75 |
| Salt | 2.5 | 2.5 |
| White onion powder | 3.0 | 3.0 |
| Monosodium glutamate | 2.8 | 2.8 |
| Sugar | 2.2 | 2.2 |
| Mushroom pieces | 1.0 | 1.0 |
| Sunflower oil | 1.0 | 1.0 |
| Parsley leaves | 0.25 | 0.25 |
| Button mushroom flavoring | 0.2 | 0.2 |
| Woodland mushroom flavoring | 0.1 | 0.1 |
| White pepper | 0.1 | 0.1 |
| Total (%) | 100.0 | 100.0 |

Disperse the sunflower oil with the salt, sugar and monosodium glutamate. Add the other powders. Mix.

### Soup Reconstitution

For a portion of 300 g: Add 250 ml of boiling water to the 50 g sachet.

Serve immediately.

In terms of soup reconstitution, a better dispersion of assembly 2 than of the simple physical mixture of the two powders was observed.

Furthermore, with assembly 2, the soup texture was judged to be smoother, creamier and more aerated than for the control soup by a trained jury of 25 individuals.

Likewise, in terms of the color, the soup prepared with assembly 2 was judged to be whiter and more pleasant than the color of the control soup.

Thus, using an assembly which has undergone a treatment to modify the conformation of the proteins makes it possible to obtain technological characteristics that the simple physical mixture of the two protein compositions does not have.

1-17. (canceled)

18. A process for producing an assembly of at least one milk protein and at least one plant protein, said process comprising the steps consisting in:
preparing an aqueous composition comprising at least one leguminous-plant protein by incorporating said at least one plant protein into water;
reducing the pH of said aqueous composition to a value of less than 5, in order to obtain an acidified composition;
raising the pH of said acidified aqueous composition to a value of between 5 and 8;
introducing at least one milk protein into said aqueous composition obtained after the pH has been raised, in order to obtain a mixture;
homogenizing the mixture obtained.

19. The process as claimed in claim 18, wherein the leguminous-plant protein is chosen from the group consisting of alfalfa, clover, lupin, pea, bean, broad bean, horse bean and lentil, and mixtures thereof.

20. The process as claimed in claim 18, wherein the leguminous-plant protein is a pea protein.

21. The process as claimed in claim 18, wherein the milk protein is at least one casein.

22. The process as claimed in claim 20, wherein the weight ratio of the pea protein to the milk protein is between 20:80 and 45:55.

23. The process as claimed in claim 22, wherein the weight ratio of the pea protein to the milk protein is 40:60.

24. The process as claimed in claim 18, wherein the total content of proteins of the assembly is between 20% and 100% by weight of dry product.

25. The process as claimed in claim 24, wherein the total content of proteins of the assembly is between 40% and 80% by weight of dry product.

26. An assembly of at least one milk protein and of at least one leguminous-plant protein, which can be obtained by means of the process as claimed in claim 18.

27. Functional agent comprising the assembly as claimed in claim 26, and preferably as an emulsifying agent, foaming agent, gelling agent, viscosifying agent, overrun agent, water-retaining agent, film-forming and/or adhesive agent, agent having a capacity in Maillard reactions, and an agent for modifying the sensory properties of the food matrices in which it is used.

28. Food composition comprising the assembly as claimed in claim 26.

29. The food composition as claimed in claim 28, wherein the food composition is chosen from the group consisting of beverages, milk products, confectionery products, milk desserts, preparations intended for clinical nutrition and/or for individuals suffering from undernourishment, preparations intended for infant nutrition, mixtures of powders intended for diet products or for sportspersons, high-protein products for dietetic nutrition, soups, sauces and culinary aids, confectionery products, meat-based products, fish-based products, cereal products such as bread, pasta, cookies, pastries, cereals and cereal bars, vegetarian products and ready meals, whitening agents such as coffee whiteners, products intended for feeding animals.

30. The food composition as claimed in claim 29, wherein the food composition is chosen from the group consisting of milk products.

31. The food composition as claimed in claim 30, wherein the milk product is chosen from the group consisting of fromage frais and ripened cheeses, cheese spreads, fermented milks, milk smoothies, yoghurts, specialty milk products and ice creams produced from milk.

32. The food composition as claimed in claim 29, wherein the food composition is chocolate.

33. The food composition as claimed claim 28, wherein the food composition is a low-fat food composition.

34. The food composition as claimed in claim 28, wherein the food composition is enriched with proteins.

35. The process as claimed in claim 18, wherein the pH is reduced to a value of less than or equal to 4.5.

36. The process as claimed in claim 18, wherein the pH is raised to a value of between 5.5 and 7.5.

37. The process as claimed in claim 18, wherein the pH is raised to a value of between 6 and 7.

38. The process as claimed in claim 18, wherein the pH is to a value of 7.

39. The process as claimed in claim 18, wherein the milk protein is at least micellar casein retentate.

40. The process as claimed in claim 18, wherein the total content of proteins of the assembly is between 30% and 90% by weight of dry product.

41. The process as claimed in claim 18, wherein the total content of proteins of the assembly is between 35% and 85% by weight of dry product.
